(19) United States
(12) Patent Application Publication
(10) Pub. No.: US 2015/0334095 A1
(43) Pub. Date: Nov. 19, 2015

(54) SYSTEM AND METHOD FOR SECURING DATA EXCHANGES, PORTABLE USER OBJECT AND REMOTE DEVICE FOR DOWNLOADING DATA

(71) Applicant: PLUG-UP INTERNATIONAL, Les Mesnil Esnard (FR)

(72) Inventor: Emmanuel THIBAUDEAU, DUCLAIR (FR)

(21) Appl. No.: 14/436,812

(22) PCT Filed: Oct. 16, 2013
(86) PCT No.: PCT/EP2013/071644

§ 371 Date: Apr. 17, 2015

(30) Foreign Application Priority Data
Oct. 19, 2012 (FR) 1259986

(51) Int. Cl. H04L 29/06

(52) U.S. Cl. CPC H04L 63/061; H04L 63/0428

(57) ABSTRACT

The technical problem to be solved is securing data exchange between at least two connected devices, regardless of the device type. The present invention is intended for at least partially solving the disadvantages of the prior art by providing a data exchange system including devices connected therebetween, part of the secret information contained in the memory of the devices never being sent. The data is thus exchanged between the connected devices with complete security and complete integrity.

### TECHNICAL FIELD OF THE INVENTION

The present invention relates to the field of the securing data exchanges between a host and a client, for example between a server and an electronic portable and connectable object. More precisely, the invention relates to a system comprising a portable electronic object which can be connected to a remote server, said system being adapted to create a secure channel of data exchange between a host and a client and proposing defense and protection strategies against intrusions and attacks.

### TECHNOLOGICAL BACKGROUND OF THE INVENTION

The digital data exchange made between different devices connected via a local or extended network poses a real security problem. In fact, the confidentiality or authenticity of data exchanged between two connected devices is barely being controlled.

However, there is a real need to control these data, their integrity and their confidentiality. By way of example there is the realisation of bank transactions done virtually by way of an extended network of Internet type. In this case the absolute necessity of exchanging data in total confidentiality is perfectly understood.

Several protocols for securing data exchanges are known from the prior art, especially protocols comprising GlobalPlatform specificities. These protocols create secure channels of data exchanges between two devices connected via a local or extended network. The data are encrypted and/or accompanied by a digital signature for verifying integrity of the data, according to the level of security to be applied. Algorithms and triple DES keys are generally used for encryption of data.

However, devices making use of the specified GlobalPlatform protocols risk especially undergoing attacks and/or intrusions. By way of example, Trojan horses which allow a hacker to take control of devices sending or receiving sensitive data.

There are also risks of access to databases hosted on devices or on servers. For example, it is possible for encryption keys for decrypting data are stolen and used improperly.

Finally, another disadvantage of data exchange according to this type of protocol is the obligation to use a remote server linked to an extended network for sending secret data to a connected device.

### GENERAL DESCRIPTION OF THE INVENTION

The technical problem to be resolved is therefore to secure data exchanges between at least two connected devices, irrespective of the type of device. The present invention proposes to resolve at least in part the disadvantages explained hereinabove by proposing a system of data exchange comprising devices connected to a network, some of the secret information contained in the memory of the devices never being transmitted. The data are therefore exchanged between the devices connected full securely and in all integrity.

For this purpose, the invention relates to a security system of data exchanges characterized in that it comprises at least two devices playing the role of host or client, whereof at least the client is portable, communicating with a network via connection or communication means, each device comprising at least one programmable non-volatile permanent memory area and data processing means, an encryption/decryption algorithm for data coupled to a first set of secret keys stored in a secret area of the device not accessible from the exterior, the devices being intended to exchange secret data securely by the processing means of at least one device via the encryption/decryption algorithm and the first set of secret keys, after having opened at least once a secure communication channel between the two devices, the host device comprising at least one second set of secret keys stored in a memory area intended to be sent to the client device, the keys of the second set being encrypted by the processing means of the host device by means of the encryption/decryption algorithm and of at least one key of the first set, the encrypted keys of the second set being sent by the processing means of the host device in a memory area of the client device, the encrypted keys of the second set being decrypted by the processing means of the client device by means of the encryption/decryption algorithm and of at least one secret key of the first set, this second set of secret keys henceforth being used with the encryption/decryption algorithm by the processing means of the host and client devices to secure data exchanged between said devices.

According to another particular feature, the security system of data exchanges is characterized in that the host device comprises a deactivation command of the client device recorded in a memory area.

According to another particular feature, the security system of data exchanges is characterized in that reactivation of the client device by a user is followed by opening of a new secure channel according to GlobalPlatform specifications.

According to another particular feature, the security system of data exchanges is characterized in that the host and client devices each comprise in a memory area a diversification algorithm, the algorithm enabling to derive of the secret keys of each set of keys stored in the secret memory area of the client device, such that only a key diversifier is transmitted between the two devices after double opening of a secure channel to calculate a set of diversified keys which will constitute the first set of keys.

According to another particular feature, the security system of data exchanges is characterized in that the encryption/decryption algorithm is a symmetrical algorithm called triple DES and the first set of keys a set of three triple DES keys, opening of a secure channel by the system being carried out via the encryption/decryption algorithm and the first set of secret keys according to a GlobalPlatform specified security protocol.

According to another particular feature, the security system of data exchanges is characterized in that the second set of secret keys is a set of three secret triple DES keys.

An additional aim of the invention is proposing a method for securing data exchanges. The method executed by the security system of data exchanges is characterized in that it comprises:
a. a closing step of the secure channel enabling data exchange between a host device and a client device of the system,
b. a selection step, by the processing means of the host device of the system, of a second set of secret keys recorded in a memory area of said device, this device only storing in a memory area a second set of secret keys,
c. an encryption step, by the processing means of the host device via the encryption/decryption algorithm and at least one secret key of the first set of keys recorded in a memory area of the host device, of at least one secret key of the second set of keys,
d. a sending step by the processing means to the second device of the system:
   of the key encrypted in the preceding step,
   of a written instruction of the key encrypted in a memory area of the client device,
e. a decryption step of the encrypted key, carried out by the processing means of the client device via the encryption/decryption algorithm making use of at least the corresponding secret key of the first set of keys, followed by recording of the decrypted key in a memory area of the client device,
f. a repetition step of steps c to e for all the keys of the second set of secret keys,
g. an opening step by the system of a new session and a new secure channel, carried out via the encryption/decryption algorithm and the second set of secret keys according to a security protocol of the GlobalPlatform type.

According to another particular feature, the method for securing data exchanges, characterized in that the opening of a secure channel carried out via the triple DES algorithm and a set of three secret keys according to a specified security protocol of the GlobalPlatform type, said triple DES algorithm and the first set of secret keys being recorded in a memory area of each device, comprises the steps following:
a. a session-opening step by the processing means of a host device of the security system, followed by generation of a session counter by a client device of the system sent to the host device, the session counter being incremented at each opening of a new session,
b. a derivation step of secret keys recorded in the memory of the client device, carried out by the processing means of said device via the triple DES algorithm making use of the session counter and a random host number generated and sent to the client device by the processing means of the host device,
c. a generation step of five derived keys S-ENC, R-ENC, C-MAC, R-MAC and S-DEK which, used with the triple DES algorithm, respectively enable to encrypt the commands sent to a device, encrypt the responses of the device, generate a signature for each command, generate a signature for each response, and encrypt confidential data,
d. a generation step by the processing means of the client device of a client cryptogram, via the triple DES algorithm making use of the derived key S-ENC, the random host number and a random client number generated by the processing means of the client device,
e. a sending step by the processing means of the client device to the host device, of the session counter, of the random client number and of the client cryptogram calculated at the preceding step, followed by calculation and generation of five derived keys by the processing means of the host device,
f. a generation step, by the processing means of the host device, of the client cryptogram via the triple DES algorithm making use of the derived key S-ENC, the random host number and the random client number generated by the processing means of the client device,
g. a comparison step by the processing means of the host device of client cryptograms respectively calculated by the client device and the host device, followed by authentication of the client device if the two calculations of the client cryptogram are identical,
h. a generation step by the processing means of the host device of a host cryptogram, via the triple DES algorithm using the derived key S-ENC, the random host number and the random client number,
i. a sending step by the processing means of the host device to the client device, of the host cryptogram calculated at the preceding step,
j. a generation step, by the processing means of the client device, of the host cryptogram via the triple DES algorithm using the derived key S-ENC, the random host number and the random client number,
k. a comparison step by the processing means of the client device of the host cryptograms respectively calculated by the host device and the client device, followed by authentication of the host device if the two calculations of the host cryptogram are identical,
l. a confirmation step of opening of a session and of the secure channel via which the next commands and/or response generated by the host and client devices will be carried out.

According to another particular feature, the method for securing data exchanges is characterized in that it comprises, upstream of the third derivation step of secret keys, a diversification step of the set of secret keys carried out by a diversification algorithm such that only the diversified keys are transmitted to the host device by the processing means of the client device.

According to another particular feature, the method for securing data exchanges is characterized in that it comprises steps causing deactivation of the client device then its reactivation by the user, followed by the opening of a new secure channel between the host device and the client device, these steps being the following:
a) an encryption step of a deactivation command by the processing means of the host device, via the triple DES algorithm making use of the derived key C-MAC enabling to incorporate a digital signature in the encrypted command,
b) a sending step by the processing means of the host device of the encrypted deactivation command to the client device,
c) a decryption step, by the processing means of the client device, of the encrypted deactivation command via the triple DES algorithm making use of the derived key C-MAC,
d) a sending step to the host device by the processing means of the client device, of a response to the deactivation command, this response being sent on the one hand in clear text and on the other hand encrypted via the triple DES algorithm making use of the derived key R-MAC, incorporating a digital signature in the response,
e) a decryption step of the response received by the host device, via the triple DES algorithm making use of the derived key R-MAC, followed by sending by the processing means of the host device of a deactivation command of the client device and an invitation to disconnect the client device,
f) a sending step by the processing means of the host device of an invitation to connect the client device to the network,
g) an opening step of a new session followed by confirmation of opening of a new secure channel according to GlobalPlatform specifications.

An additional aim of the invention is proposing a portable user object comprising a non-volatile secure memory area and data-processing means, the portable object being characterized in that it also comprises:
connection or communication means to an external device,
an encryption/decryption algorithm and at least one set of secret keys stored in the memory area,
an operating system executed by the processing means, the operating system comprising the algorithms and commands necessary for opening of a GlobalPlatform-specified secure channel between the portable object and an external device connected to said object,
interpretation means of a deactivation command sent by an external device, the portable object sending in return to said device at least one response comprising a digital signature ensuring the integrity of the response,
interpretation means of a writing command, in a memory area, of a new set of secret keys, the portable user object being a client device of the security system of data exchanges according to the invention.

According to another particular feature, the portable user object is characterized in that the connection means are of USB type.

According to another particular feature, the portable user object is characterized in that the connection means utilise a protocol of radioelectric type.

According to another particular feature, the portable user object is characterized in that it comprises a diversification algorithm of secret keys, the algorithm deriving the secret keys stored in a non-volatile memory area of the portable object such that only the keys derived by the diversification algorithm are transmitted to a remote device.

According to another particular feature, the portable user object is characterized in that the object is a chip card.

An additional aim of the invention is proposing a remote device for downloading data to a portable user object according to the invention, the device comprising a secure non-volatile memory area and data-processing means, the remote device being characterized in that it also comprises:
connection means or means for setting up communication to an external device,
an encryption/decryption algorithm and at least one set of secret keys stored in the memory area,
an operating system executed by the processing means, the operating system comprising the algorithms and commands necessary for opening a session and a secure channel according to GlobalPlatform specifications between the remote device and a portable object connected to said remote device,
selection means of a new set of secret keys stored in a non-volatile memory area of the remote device, encrypted by the encryption/decryption algorithm and sent by the data-processing means to a portable object connected to the remote device.

According to another particular feature, the remote device is characterized in that the device comprises connection means with contact.

According to another particular feature, the remote device is characterized in that the device comprises connection means making use of a protocol of radioelectric type.

According to another particular feature, the remote device is characterized in that it comprises a deactivation command intended to be sent to a portable object connected to said remote device, the processing means of the portable object sending back a response comprising a digital signature ensuring integrity of the response, this command being configured to make the portable user object unusable until its deactivation then its reactivation by a user, the remote device comprising the commands necessary for the opening a new session and a new secure channel of data exchange.

According to another particular feature, the remote device is characterized in that said device is a remote server, said server being connected to the portable user object via a local or extended network.

According to another particular feature, the remote device is characterized in that said device is a chip card, said card being connected to the portable user object via a local or extended network.

The invention, with its characteristics and advantages, will emerge more clearly from the description given in reference to the attached diagrams, in which:

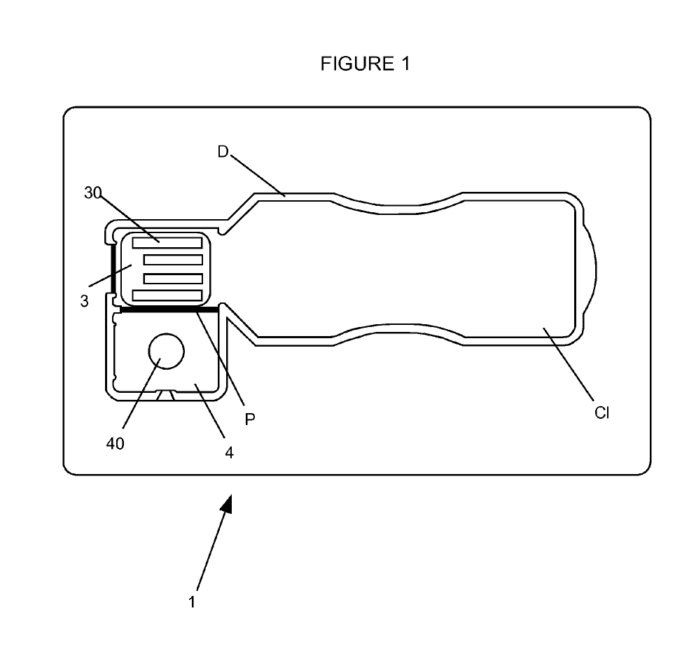

FIG. 1 illustrates the invention in an embodiment.

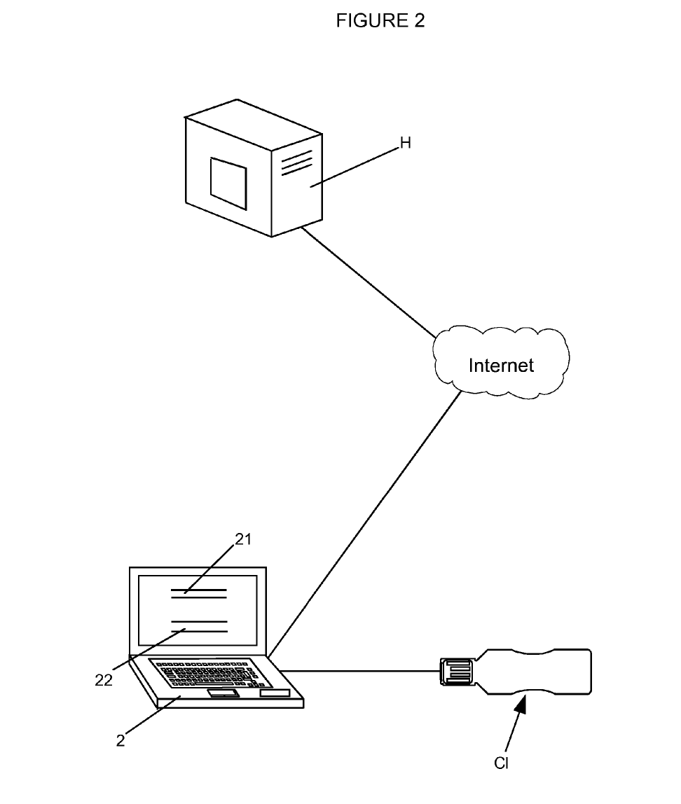

FIG. 2 illustrates the portable user object in an embodiment.

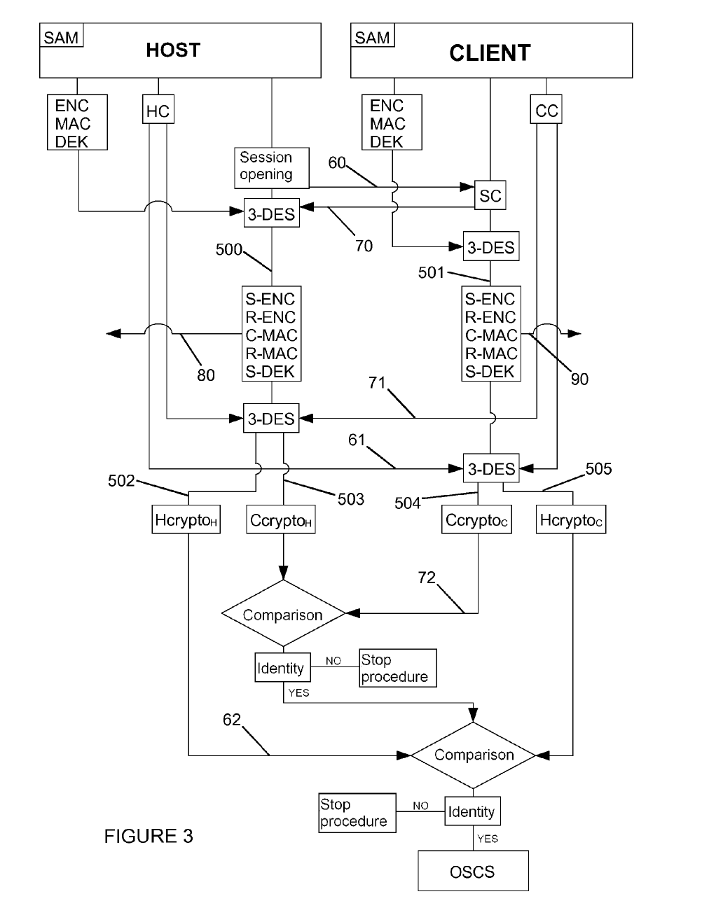

FIG. 3 illustrates the steps for opening of a secure channel having the GlobalPlatform specifications.

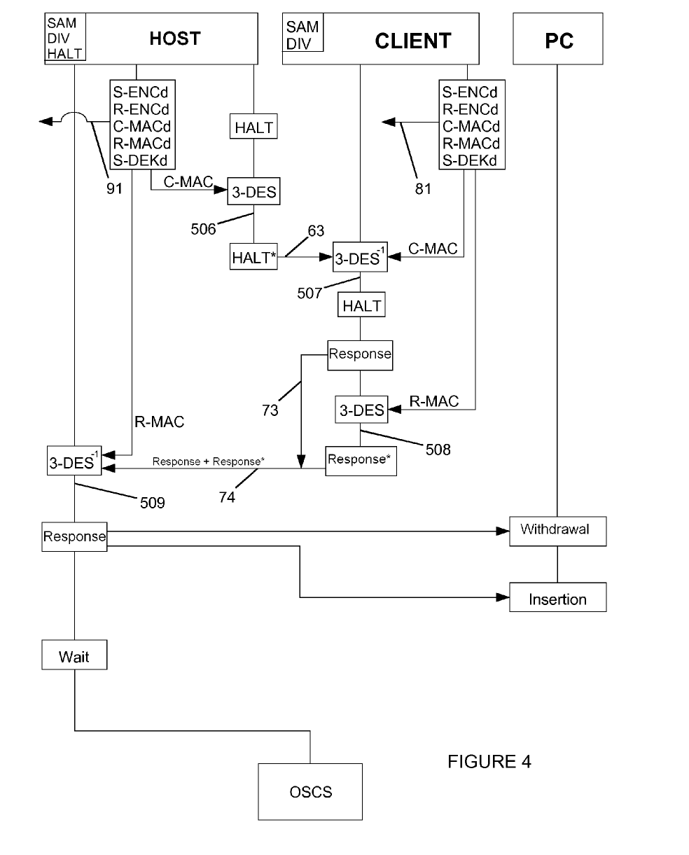

FIG. 4 illustrates the steps describing the operation of a deactivation command of the client device.

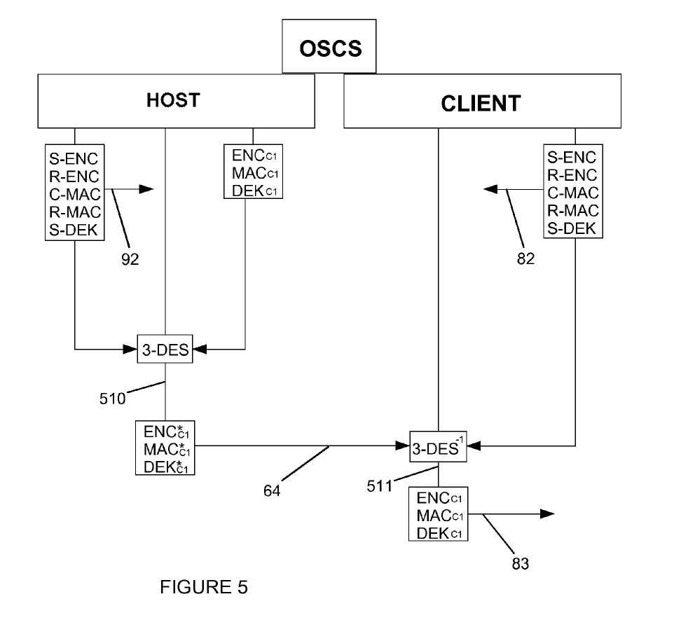

FIG. 5 illustrates the steps of the method for securing data exchanges according to an embodiment.

### DESCRIPTION OF PREFERRED EMBODIMENTS OF THE INVENTION

In reference to FIGS. 1 and 2, the security system of data exchanges will now be described.

In an embodiment, the security system of data exchanges comprises at least two devices, for example and non-limiting a host device (H) and a client device (Cl), connected and communicating with a local or extended network.

For example, the client device is portable and connectable to a computer device (2), for example a personal computer, linked to the local or extended network. Portable device means a device which can fit, for example, in a clothing pocket. The portable client device (Cl) is for example contained in a chip card (1) comprising a body made of conventional synthetic material, for example ABS (Acrylonitrile Butadiene Styrene) or PVC (Vinyl Polychloride). According to a variant embodiment, the body of the card can be made of biodegradable material. In an embodiment, the card comprises a pre-cut detachable part intended to form the client device (Cl), said device being a portable user object (Cl).

The detachable part of the card is delimited by a linear recess (D), and is attached to the rest of the body of the card by breakable connecting means interrupting the linear recess.

In an embodiment, the portable user object (Cl) comprises means embodying a fold line (P). In the example shown in FIG. 1, the fold line is embodied by localised thinning of the body of the card. This thinning could, for example and non-restrictively, be created by punching, by milling, by laser cutting or any other machining means.

It is evident that the fold line separates two areas respectively called resting (3) and folding (4).

After cutting of the computer object and folding by turning down of the folding on the resting, the folding and the resting being connected by clipping means (40), the part present under the connector now has a thickness compatible with the dimensions of a female USB connector. In this configuration, the portable user object can be connected to a computer host (2) via a USB port, for example and non-limiting a user terminal.

In a preferred embodiment, the card (1) is made in dimensions respecting the format of the standard ISO 7816, especially the standard ISO 7816-1 relative to the physical characteristics of cards with chip.

The portable user object (Cl) comprises especially an electronic device connected to the body of the object for example by means of conventional adhesive during an integration step of the electronic device. The electronic device comprises connection means (30) of bus computer type with series transmission. In some embodiments, the electronic device is an electronic chip connected electrically according to the USB standard (Universal Serial Bus) to a sticker having electrically separated areas of contact, made according to a process known to the person skilled in the art: the electronic chip is placed under stickers having areas of contact, then the electric contacts of the chip are connected to the areas of contact of said sticker.

In an alternative embodiment, the portable user object comprises contactless communication means, for example and non-limiting a radioelectric antenna of wifi, RFID type or any contactless communication protocol known to the person skilled in the art.

The electronic chip can comprise, for example and non-limiting, at least one microcontroller, such as for example and non-limiting a microprocessor comprising a volatile memory, a USB controller or a radioelectric antenna of RFID type, one or more memory spaces, for example permanent and programmable non-volatile secure memories integrated or not into the microcontroller. Contrary to the case of chips made according to the standard ISO 7816, clock signals of peripherals of USB type are not transmitted by the USB connector, the chip will therefore comprise its clock circuit integrated or not into a microcontroller. This clock circuit could, for example and non-restrictively, comprise a resonator or a quartz.

In an embodiment, the areas of contact are carried out by a sticker with eight contacts. contrary to stickers of ISO 7816 format conventionally used on a chip card, the areas of contact corresponding to the contacts ISO C1 to C4 have been extended so as to have the dimensions of areas of contact of the sticker correspond to those of a USB connector and respect the 7816-2 standard relative to the dimensions and placement of contacts. For this, the length of the areas of contact corresponding to the contacts ISO C5 to C8 has been shortened. With a USB connector comprising only four tracks, the areas of contact corresponding to the contacts ISO C5 to C8 will therefore not be used. According to a first embodiment, these areas of contact will be each isolated from each other, but will not be cabled to the microcircuit. According to another embodiment, the areas of contact corresponding to the contacts ISO C5 to C8 could be isolated from the contacts ISO C2 to C4 but will not be isolated from each other and will be connected to the contact ISO C1 so as to form just one area of contact.

Therefore, the portable user object (Cl) forms a connectable computer member either according to the standard USB or for example according to the RFID standard, a microcontroller of the electronic chip being programmed by programming means such that said portable object performs as a man/machine interface once connected, for example to a terminal (2).

In an embodiment, the host device (H) of the security system of data exchanges is a computer server comprising at least one non-volatile permanent and programmable secure memory area, data-processing means, for example a microprocessor, an operating system being installed in a memory area of the server (H) to manage at least the data exchanges between host (H) and client (Cl) devices. The server (H) also comprises connection means, for example to an extended or local network. In an embodiment, the connection means are of contact type, for example and non-limiting the connections to the extended network or local are made via wired connection means. In an alternative embodiment, the server comprises radioelectric wireless communication means, wifi, RFID type or any contactless communication protocol known to the person skilled in the art. In another embodiment, the host device (H) is a chip card (1) having similar properties to the portable user object having the role of client device.

To enable secure data exchanges, the security system puts in place, in an embodiment, a data exchange protocol having the GlobalPlatform specifications, well known to the person skilled in the art. For example and non-limiting, the security system is capable of putting in place a protocol for securing data according to the specifications of “GlobalPlatform-Card Specification—version 2.2”, published in March 2006. The aim of such protocols is creation, by the security system of data exchanges, of a security channel for exchanging data between the host (H) and client (Cl) devices communicating via a local or extended network.

For enabling the opening of this secure channel, the host (H) and client (Cl) devices comprise, in an embodiment, at least one encryption/decryption algorithm for data and at least one set of keys of encryptions recorded in a secret area of the device, this area being non-accessible from the exterior. For example and non-limiting, the keys of each set are symmetrical. For example, the encryption/decryption algorithm utilised is an algorithm called triple DES (3-DES, “Data Encryption standard”). Each set of secret keys comprises for example three secret keys 3-DES, noted ENC, MAC and DEK. The key ENC is a secret key for data encryption, ensuring confidentiality of data exchanged. The secret key MAC is an integrity key. The algorithm 3-DES making use of the secret key MAC on a datum generates a digital signature accompanying each datum encrypted by the algorithm and the key MAC. This digital signature ensures that the data transferred from one device to the other are not corrupted. Finally, the key DEK is a secret encryption key of confidential data, and lends extra protection to sensitive data, for example and non-limiting containing information on user data.

In an embodiment, the host (H) and client (Cl) devices comprise an operating system, run by the processing means, comprising the algorithms and commands necessary for opening of a secure channel having the GlobalPlatform specifications enabling secure exchange of data between the client, for example a portable user object (Cl), and the host (H), for example a server.

In an embodiment and in reference to FIG. 3, the opening method of a secure channel having the GlobalPlatform specifications between the client device (Cl) and the host device (H) of the security system of data exchanges will now be described. The opening of this channel is carried out via an algorithm 3-DES recorded in a secure non-volatile memory area of the host device and of the client device, and a set of three secret keys ENC, MAC

AND DEK recorded in a secret area of each device (H, Cl), not accessible from the exterior.

During the first step, the processing means of the host device (H) control opening of a new session. Information indicating opening of the session is sent to the client device (Cl) by the processing means of the host device (H). On receipt of the information, the processing means of the client device generate (60) a session counter (SC) incremented at each opening of a new session. This session counter is stored in a memory area of the client device (Cl).

During the second step, the processing means of the client device (Cl) carry out a derivation operation (501) of the three secret keys ENC, MAC AND DEK, via the algorithm 3-DES making use of the session counter (SC) and a random host number (HC) generated by the processing means of the host device (H), said number random (HC) being sent (61) to the client device (Cl) and recorded in the memory of the client device.

Following this derivation step, five derived secret keys are generated (90) by the processing means of the client device (Cl), and recorded in a memory area of the device (Cl). The first key, called S-ENC, enables the encryption of the commands sent to a device (H, Cl) by the other device (H, Cl). The second key, called R-ENC, enables the encryption of the responses sent to a device by the other device. The two keys called C-MAC and R-MAC enables respectively the generation of a signature for each command and for each response sent, ensuring integrity of the data transferred. Finally, the fifth key, called S-DEK, enables the encryption of the confidential data, whether commands or responses.

During the fourth step, the processing means of the client device (Cl) generate (504) a client cryptogram (Ccrypto_{c}), via the algorithm 3-DES making use of the derived key S-ENC as well as the random host number (HC) and a random client number (CC) generated by the processing means of the client device (Cl).

During the fifth step, this client cryptogram (Ccrypto_{c}), the session counter (SC) and the random client number (CC) are sent to the host device (H) by the processing means of the client device (Cl). The client cryptogram (Ccrypto_{c}), the session counter (SC) and the random client number (CC) are recorded in a memory area of the host device (H). At the same time, the processing means of the host device (H) calculate (500, 80) the five derived keys S-ENC, R-ENC, C-MAC, R-MAK and S-DEK via the triple DES algorithm making use of the session counter (SC) and the random host number (HC).

With the data received at the fifth step, the processing means of the host device (H) calculate (503) the client cryptogram (Ccrypto_{H}) via the triple DES algorithm making use of the derived key S-ENC, the random host number (HC) and the random client number (CC).

During the seventh step, the processing means of the host device (H) compare the cryptograms client (Ccrypto_{c}, Ccrypto_{H}) respectively calculated by the client device (Cl) and the host device (H). If the two client cryptograms (Ccrypto_{c}, Ccrypto_{H}) are identical, the client device (Cl) is authenticated by the processing means of the host device (H).

During the eighth step, the processing means of the host device (H) calculate (502) a host cryptogram (Hcrypto_{H}), via the algorithm 3-DES making use of the derived key S-ENC, the random host number (HC) and the random client number (CC). This host cryptogram (Hcrypto_{H}) is recorded in a memory area of the host device (H).

During the ninth step, this host cryptogram (Hcrypto_{H}) is sent (62) to the client device (Cl) by the processing means of the host device (H). The host cryptogram (Hcrypto_{H}) is recorded in a memory area of the client device (Cl).

With the data received at the ninth step, the processing means of the client device (Cl) calculate (505) the host cryptogram (Hcrypto_{c}) via the algorithm 3-DES making use of the derived key S-ENC, the random host number (HC) and the random client number (CC).

During the eleventh step, the processing means of the client device (Cl) compare the host cryptograms (Hcrypto_{H}, Hcrypto_{c}) respectively calculated by the client device (Cl) and the host device (H). If the two host cryptograms (Hcrypto_{H}, Hcrypto_{c}) are identical, the host device (H) is authenticated by the processing means of the client device (Cl).

This method concludes by confirmation of opening by the security system of data exchanges of a secure channel (OSCS), via which the next commands and/or response generated by the host (H) and client (Cl) devices will be carried out.

In an embodiment, a diversification step of derived keys obtained at the third step of the opening method of a secure channel having GlobalPlatform specifications is carried out via a diversification algorithm stored in a memory area of the host (H) and client (Cl) devices. For example and non-limiting, this diversification algorithm is also an algorithm 3-DES. So, only the derived keys, diversified and recorded in a memory area of the host device (H) and of the client device (Cl) are used by the security system for data exchanges between a host device (H) and a client device (Cl), such that the initial keys (ENC, MAC, DEK) are never accessible in case of attack or attempted attack. In the event of attack or suspicion of attack, the security system will simply have to resend different diversified keys prior to opening a secure channel.

In an embodiment, one of the devices of the security system of data exchanges, for example and non-limiting the host device (H), comprises a set of additional secret keys (ENC_{c1}, MAC_{c1}, DEK_{c1}) recorded in a programmable and permanent non-volatile memory area of the device (H). For example and non-limiting, this second set of secret keys comprises three secret keys 3-DES: a key ENC_{c1}, a key MAC_{c1} and a key DEK_{c1}. In an embodiment, the security system of data exchanges utilises this second set of keys (ENC_{c1}, MAC_{c1}, DEK_{c1}) in place of the first set of used key (S-ENC, R-ENC, C-MAC, R-MAC, S-DEK), derived from the set of keys (ENC, MAC, DEK), which has served to open a first secure channel, if the processing means of one of the devices (H, Cl) of the system, host or client, suspects an attack or a violation of the rules of confidentiality and/or integrity imposed by said secure channel.

In reference to FIG. 5, the method describing replacement of a first set of keys 3-DES (ENC, MAC, DEK) by a second set of keys 3-DES (ENC_{c1}, MAC_{c1}, DEK_{c1}), followed by the opening of a new secure channel will now be described.

During the first step, for example in case of violation of rules of confidentiality and/or integrity of the secure channel suspected by the processing means of at least one device (H, Cl) of the security system, the processing means of said device (H, Cl) control closing of the secure channel underway.

During the second step, the processing means of the device (H, Cl) of the system in which a second set of secret keys (ENC_{c1}, MAC_{c1}, DEK_{c1}) is stored, for example and non-limiting the host device (H), select said second set of secret keys.

During the third step, the processing means of the host device (H) encrypt (510) the first secret key (ENC*_{c1}) of the second set of keys (ENC_{c1}, MAC_{c1}, DEK_{c1}), via the encryption/decryption algorithm 3-DES by making use of at least one secret key of the first set of keys (ENC, MAC, DEK). For example, the diversified keys (S-ENC, R-ENC, C-MAC, R-MAC, S-DEK), recorded (92) in a memory area of the host device (H), are used to encrypt the first secret key (ENC*_{c1}) of the second set of keys (ENC_{c1}, MAC_{c1}, DEK_{c1}).

During the fourth step, the processing means of the host device (H) send (64) to the second device (Cl), for example and non-limiting the client device (Cl), the key encrypted (ENC*_{c1}) at the preceding step as well as a written instruction of the key encrypted (ENC*_{c1}) in the memory of the client device (Cl). In an alternative embodiment, the written instruction of the key encrypted (ENC*_{c1}) in the memory of the client device (Cl) forms part of the operating system of the client device (Cl).

During the fifth step, the algorithm 3-DES recorded in a memory area of the client device (Cl), making use of at least one secret key of the first set of keys (ENC, MAC, DEK), decrypts (511) the key encrypted (ENC*_{c1}) by the host device (H) and sent to the client device (Cl) in the preceding step. For example, the diversified keys (S-ENC, R-ENC, C-MAC, R-MAC, S-DEK), recorded (22) in a memory area of the client device (Cl), are used to decrypt the first secret key (ENC*_{c1}) of the second set of keys (ENC_{c1}, MAC_{c1}, DEK_{c1}). The decrypted key (ENC_{c1}) is recorded (83) in a memory area of the client device (Cl).

Steps three to five are repeated for all the keys (MAC_{c1}, DEK_{c1}) of the second set of secret keys. Finally, the security system of data exchanges control opening of a new secure channel according to the method explained above in the description, the opening being carried out via the encryption/decryption algorithm 3-DES making use of the keys of the second set of secret keys (ENC_{c1}, MAC_{c1}, DEK_{c1}).

To complete this process, the client device, for example a portable user object (Cl), comprises interpretation means of a writing command, in a memory area of said device (Cl), of a new set of secret keys (ENC_{c1}, MAC_{c1}, DEK_{c1}). The host device (H) per se comprises selection means of a new set of secret keys (ENC_{c1}, MAC_{c1}, DEK_{c1}) stored in a non-volatile memory area of the host device (H).

In an embodiment in reference to FIG. 4, the host device (H) comprises a deactivation command (HALT) of the client device (Cl), the command being stored in a memory space of the host device (H). This command is integrated such that the processing means of the host device (H) are certain that only the user controls the client device (Cl), and not a malicious program, for example of Trojan horse type.

Therefore, in an embodiment, the method for securing data exchanges comprises a series of optional steps causing deactivation of the client device (Cl) then its reactivation by the user, followed by opening of a secure channel.

During the first optional step, the processing means of the host device (H) encrypt (506) the deactivation command stored in a memory area of the host device (H), via the algorithm 3-DES making use of the derived key C-MAC. This step therefore integrates a digital signature into the encrypted command (HALT*). In an alternative embodiment, the set of keys (S-ENC, R-ENC, C-MAC, R-MAC, S-DEK) has been derived by a diversifier (DIV). The resulting keys (S-ENCd, R-ENCd, C-MACd, R-MACd, S-DEKd) are recorded on the one hand (91) in a memory area of the host device (H) and on the other hand (81) in a memory area of the client device (Cl).

During the second optional step, the processing means of the host device (H) send (63) the encrypted deactivation command (HALT*) to the client device (Cl).

During the third optional step, the processing means of the client device (Cl) decipher (507) the deactivation command (HALT) via the algorithm 3-DES and the secret key C-MAC. This step certifies authenticity of the deactivation command received.

During the fourth optional step, the processing means of the client device (Cl) send (73) to the host device (H) a response to the deactivation command. This response is sent on the one hand in clear text (73) and on the other hand (74) unencrypted and signed (508) via the algorithm 3-DES making use of the key R-MAC, incorporating a digital signature into the signed response. So that steps three and four can be conducted, the client device (Cl), for example a portable user object, comprises interpretation means of an deactivation command sent by the host device (H), for example an external device.

During the fifth optional step, the response encrypted received by the host device (H) is decrypted (509) by the processing means of said device (H), via the algorithm 3-DES and the key R-MAC. This step enables to certify the authenticity of the response received. The authentication of the response is immediately followed by deactivation of the client device (Cl), then sending (21), by the processing means of the host device (H), of an invitation to disconnect the client device (Cl).

During the optional sixth step, the processing means of the host device (H) send via the network an invitation (22) to connect the client device (Cl) to the network.

During the final optional step, following reactivation and/or reconnection of the client device (Cl) carried out by a user, the security system of data exchanges controls opening of a new session and confirms opening of a new secure channel (OSCS) according to the method described above in the description. The host (H) and client (Cl) devices comprise commands, recorded in a memory area of said devices (H, Cl), necessary for opening a new session and a new secure channel of data exchanges.

The present application describes various technical characteristics and advantages in reference to the figures and/or to various embodiments. The person skilled in the art will understand that the technical characteristics of a given embodiment can in fact be combined with characteristics of another embodiment unless otherwise expressed or it is evident that these characteristics are incompatible. Also, the technical characteristics described in a given embodiment can be isolated from the other characteristics of this mode, unless otherwise expressed.

It must be evident for persons skilled in the art that the present invention enables embodiments in many other specific forms without departing from the field of application of the invention as claimed. Consequently, the present embodiments must be considered by way of illustration, but can be modified in the field defined by the scope of the attached claims, and the invention must not be limited to the details given hereinabove.

1. A secure system for exchanges of secret data comprising at least two devices playing the role of host (H) or client (Cl), whereof at least the client is portable, communicating with a network via connection or communication means, each device (H, Cl) comprising at least one programmable and permanent non-volatile memory area and data-processing means, an encryption/decryption algorithm for data coupled to a first set of secret keys (ENC, MAC, DEK) stored in a secret area of the device not accessible from the exterior, the devices being intended to exchange secret data securely by the processing means of at least one device via the encryption/decryption algorithm and the first set of secret keys (ENC, MAC, DEK), after having opened at least once a secure communication channel between the two devices (H, Cl), the host device comprising at least one second set of secret keys (ENC_{c1}, MAC_{c1}, DEK_{c1}) stored in a memory area intended to be sent to the client device (Cl), wherein the keys of the second set (ENC_{c1}, MAC_{c1}, DEK_{c1}) are encrypted by the processing means of the host device (H) by means of the encryption/decryption algorithm and of at least one key of the first set (ENC, MAC, DEK), the encrypted keys of the second set (ENC*_{c1}, MAC*_{c1}, DEK*_{c1}) being sent by the processing means of the host device (H) in a memory area of the client device (Cl), the encrypted keys of the second set (ENC*_{c1}, MAC*_{c1}, DEK*_{c1}) being decrypted by the processing means of the client device (Cl) by means of the encryption/decryption algorithm and of at least one secret key of the first set (ENC, MAC, DEK), this second set of secret keys (ENC_{c1}, MAC_{c1}, DEK_{c1}) being now utilised with the encryption/decryption algorithm by the processing means of the host and client devices (H, Cl) to secure the data exchanged between said devices.

2. The secure system for data exchanges according to claim 1, wherein the host device (H) comprises a deactivation command (HALT) of the client device (Cl) recorded in a memory area.

3. The secure system for data exchanges according to claim 1, wherein reactivation of the client device (Cl) by a user is followed by the opening of a new secure channel according to GlobalPlatform specifications.

4. The secure system for data exchanges according to claim 1, wherein the host (H) and client (Cl) devices each comprise in a memory area a diversification algorithm, the algorithm enabling to derive the secret keys (ENC, MAC, DEK) of each set of keys stored in the secret memory area of the client device (Cl), such that only a key diversifier is transmitted between the two devices (H, Cl) after a double opening of a secure channel to calculate a set of diversified keys which will constitute the first set of keys.

5. The secure system for data exchanges according to claim 1, wherein the encryption/decryption algorithm is a symmetrical algorithm called triple DES and the first set of keys (ENC, MAC, DEK) a set of three triple DES keys, the opening of a secure channel by the system being carried out via the encryption/decryption algorithm (3-DES) and the first set of secret keys (ENC, MAC, DEK) according to a GlobalPlatform specified security protocol.

6. The secure system for data exchanges according to claim 1, wherein the second set of secret keys (ENC_{c1}, MAC_{c1}, DEK_{c1}) is a set of three secret triple DES keys.

7. A method for securing data exchanges in a secure channel, executed by the security system according to claim 1, comprising:
a) a closing step of the secure channel enabling data exchange between a host device (H) and a client device (Cl) of the system, controlled by said system,
b) a selection step, by the processing means of the host device (H) of the system, of a second set of secret keys (ENC_{c1}, MAC_{c1}, DEK_{c1}) recorded in a memory area of said device (H), this device storing in a memory area only a second set of secret keys (ENC_{c1}, MAC_{c1}, DEK_{c1}),
c) an encryption step (510), by the processing means of the host device (H) via the encryption/decryption algorithm and at least one secret key of the first set of keys (ENC, MAC, DEK) recorded in a memory area of the host device (H), of at least one secret key of the second set of keys (ENC_{c1}, MAC_{c1}, DEK_{c1}),
d) a sending step (64) by the processing means to the second device of the system:
of the key encrypted in the preceding step,
of a written instruction of the key encrypted in a memory area of the client device (Cl),
e) a decryption step (511) of the encrypted key, carried out by the processing means of the client device (Cl) via the encryption/decryption algorithm (3-DES) making use of at least the corresponding secret key of the first set of keys (ENC, MAC, DEK), followed by the recording (83) of the decrypted key in a memory area of the client device (Cl),
f) a repetition step of steps c to e for all the keys of the second set of secret keys (ENC_{c1}, MAC_{c1}, DEK_{c1}),
g) an opening step by the system of a new session and a new secure channel, carried out via the encryption/decryption algorithm (3-DES) and the second set of secret keys (ENC_{c1}, MAC_{c1}, DEK_{c1}) according to a security protocol of GlobalPlatform type.

8. The method for securing data exchanges according to claim 7, wherein opening of a secure channel carried out via the triple DES algorithm and a set of three secret keys (ENC, MAC, DEK) according to a security protocol of GlobalPlatform type, said triple DES algorithm and the first set of secret keys being recorded in a memory area of each device (H, Cl), comprises the following steps:
a) a session-opening step by the processing means of a host device (H) of the security system, followed (60) by generation of a session counter (SC) by a client device (Cl) of the system sent (70) to the host device (H), the session counter being incremented at each opening of a new session,
b) a derivation step (501) of secret keys (ENC, MAC, DEK) recorded in the memory of the client device (Cl), carried out by the processing means of said device via the triple DES algorithm making use of the session counter (SC) and a random host number (HC) generated and sent (61) to the client device (Cl) by the processing means of the host device (H),
c) a generation step (90) of five derived keys S-ENC, R-ENC, C-MAC, R-MAC and S-DEK which, used with the triple DES algorithm, enable respectively to encrypt (S-ENC) the commands sent to a device, to encrypt (R-ENC) the responses of the device, to generate a signature (C-MAC) for each command, to generate a signature (R-MAC) for each response, and to encrypt (S-DEK) confidential data,
d) a generation step (504) by the processing means of the client device (Cl) of a client cryptogram (Ccrypto_{c}), via the triple DES algorithm making use of the derived key S-ENC, the random host number (HC) and a random client number (CC) generated by the processing means of the client device (Cl),
e) a sending step (70, 71, 72) by the processing means of the client device (Cl) to the host device (H), of the session counter (SC), of the random client number (CC) and of the client cryptogram (Ccrypto_{c}) calculated at the preceding step, followed by calculation (500) and generation (80) of the five derived keys (S-ENC, R-ENC, C-MAC, R-MAC, S-DEK) by the processing means of the host device (H),
f) a generation step (503), by the processing means of the host device (H), of the client cryptogram (Ccrypto_{H}) via the triple DES algorithm making use of the derived key S-ENC, the random host number (HC) and the random client number (CC) generated by the processing means of the client device (Cl),
g) a comparison step by the processing means of the host device (H) of client cryptograms (Ccrypto_{c}, Ccrypto_{H}) respectively calculated by the client device (Cl) and the host device (H), followed by the authentication of the client device (Cl) if the two calculations of the client cryptogram (Ccrypto_{c}, Ccrypto_{H}) are identical,
h) a generation step (502) by the processing means of the host device (H) of a host cryptogram (Hcrypto_{H}), via the triple DES algorithm making use of the derived key S-ENC, the random host number (HC) and the random client number (CC),
i) a sending step (62) by the processing means of the host device (H) to the client device (Cl), of the host cryptogram (Hcrypto_{H}) calculated at the preceding step,
j) a generation step (505), by the processing means of the client device (Cl), of the host cryptogram (Hcrypto_{c}) via the triple DES algorithm making use of the derived key S-ENC, the random host number (HC) and the random client number (CC),
k) a comparison step by the processing means of the client device (Cl) of host cryptograms (Hcrypto_{H}, Hcrypto_{c}) respectively calculated by the host device (H) and the client device (Cl), followed by authentication of the host device (H) if the two calculations of the host cryptogram (Hcrypto_{H}, Hcrypto_{c}) are identical,
l) a confirmation step of the opening of a session and of the secure channel (OSCS) via which the next commands and/or response generated by the host and client devices will be carried out.

9. The method for securing data exchanges according to claim 7, it comprises comprising, upstream of the third derivation step of the secret keys (ENC, MAC, DEK), a diversification step of the set of secret keys carried out by a diversification algorithm such that only the diversified keys are transmitted to the host device (H) by the processing means of the client device (Cl).

10. The method for securing data exchanges according to claim 7, comprising steps causing deactivation of the client device (Cl) then its reactivation by the user, followed by opening of a new secure channel between the host device (H) and the client device (Cl), these steps being the following:
a) an encryption step (506) of a deactivation command (HALT) by the processing means of the host device (H), via the triple DES algorithm making use of the derived key C-MAC enabling to incorporate a digital signature in the encrypted command (HALT*),
b) a sending step (63) by the processing means of the host device (H) of the encrypted deactivation command (HALT*) to the client device (Cl),
c) a decryption step (507), by the processing means of the client device (Cl), of the encrypted deactivation command (HALT*) via the triple DES algorithm making use of the derived key C-MAC,
d) a sending step to the host device (H) by the processing means of the client device (Cl) of a response to the deactivation command (HALT), this response being sent on the one hand (73) in clear text and on the other hand (74) encrypted (508) via the triple DES algorithm making use of the derived key R-MAC, incorporating a digital signature into the response,
e) a decryption step (509) of the response received by the host device (H), via the triple DES algorithm making use of the derived key R-MAC, followed by the sent by the processing means of the host device (H) of a deactivation command of the client device (Cl) and of an invitation to disconnect (21) the client device (Cl),
f) a sending step by the processing means of the host device (H) of an invitation to connect (22) the client device (Cl) to the network,
g) an opening step of a new session followed by confirmation of the opening of a new secure channel (OSCS) according to GlobalPlatform specifications.

11. The portable user object (Cl) comprising a secure non-volatile memory area and data-processing means, the portable object comprising:
connection or communication means to an external device,
an encryption/decryption algorithm (3-DES) and at least one set of secret keys (ENC, MAC, DEK) stored in the memory area,
an operating system for execution by the processing means, the operating system comprising the algorithms and commands necessary for the opening of a GlobalPlatform specified secure channel between the portable object (Cl) and an external device (H) connected to said object,
interpretation means of a deactivation command (HALT) sent by an external device (H), the portable object (Cl) sending in return to said device (H) at least one response comprising a digital signature ensuring the integrity of the response,
interpretation means of a writing command, in a memory area, of a new set of secret keys (ENC_{c1}, MAC_{c1}, DEK_{c1}), and
the portable user object (Cl) being configured to be contained in the security system of data exchanges according to claim 1.

12. The portable user object according to claim 11, wherein the connection means are of USB (30) type.

13. The portable user object according to claim 11, wherein the connection means utilise a protocol of radioelectric type.

14. The portable user object (Cl) according to claim 11, comprising a diversification algorithm of secret keys, the algorithm enabling to derive the secret keys stored in a non-volatile memory area of the portable object (Cl), such that only the keys derived by the diversification algorithm are transmitted to a remote device (H).

15. The portable user object according to claim 11, wherein the object is a chip card (1).

16. A remote device (H) for downloading data capable of downloading data to a portable user object (Cl) according to claim 11, comprising a secure non-volatile memory area and data-processing means, the remote device comprising:
connection means or means for setting up communication to an external device,
an encryption/decryption algorithm (3-DES) and at least one set of secret keys (ENC, MAC, DEK) stored in the memory area,
an operating system executable by the processing means, the operating system comprising the algorithms and commands necessary for opening session and a secure channel according to GlobalPlatform specifications between the remote device (H) and a portable object (Cl) connected to said remote device, and
selection means of a new set of secret keys (ENC_{c1}, MAC_{c1}, DEK_{c1}) stored in a non-volatile memory area of the remote device, encrypted by the encryption/decryption algorithm (3-DES) and sent by the data-processing means to a portable object (Cl) connected to the remote device (H).

17. The remote device according to claim 16, wherein the device (H) comprises connection means with contact.

18. The remote device according to claim 16, wherein the device (H) comprises connection means making use of a protocol of radioelectric type.

19. The remote device according to claim 16, comprising a deactivation command (HALT) for sending to a portable object (Cl) connected to said remote device (H), the processing means of the portable object (Cl) sending back a response comprising a digital signature ensuring integrity of the response, this command (HALT) being configured to make the portable user object (Cl) unusable until its deactivation then its reactivation by a user, the remote device (H) comprising the commands necessary for opening a new session and a new secure channel of data exchange.

20. The remote device according to claim 16, wherein said device (H) is a remote server, said server being connected to the portable user object (Cl) via a local or extended network.

21. The remote device according to claim 16, wherein said device (H) is a chip card (1), said card being connected to the portable user object (Cl) via a local or extended network.
